(19) United States
(12) Patent Application Publication
(10) Pub. No.: US 2026/0269310 A1
(43) Pub. Date: Sep. 10, 2026

(54) COATINGS, BATTERIES, AND METHODS OF MAKING THE SAME

(71) Applicant: CORNING INCORPORATED, CORNING, NY (US)

(72) Inventors: Michael Edward Badding, Campbell, NY (US); Zhen Song, Painted Post, NY (US); Jianmeng Su, Jiangsu (CN); Tongping Xiu, Shanghai (CN)

(21) Appl. No.: 19/471,064

(22) PCT Filed: Apr. 1, 2024
(86) PCT No.: PCT/US2024/022446

§ 371 Date: Sep. 30, 2025

(30) Foreign Application Priority Data
Apr. 7, 2023 (CN) 202310369561.8

(51) Int. Cl. H01M 10/0562; H01M 10/0525; H01M 50/109

(52) U.S. Cl. CPC H01M 10/0562; H01M 10/0525; H01M 50/109; H01M 2300/0071; H01M 2300/008; H01M 2300/0094

(57) ABSTRACT

Batteries include a cathode, a solid-state electrolyte, and an anode. A coating disposed on the solid-state electrolyte is positioned between the cathode and the solid-state electrolyte. The coating can include fluorine in a range from about 10 atom % to about 50 atom %. The anode can be a lithium-containing anode. A method of forming a coating on a solid-state electrolyte includes disposing an aqueous solution comprising a lithium and fluorine containing salt on a first major surface of the solid-state solution. The aqueous solution can contact the first major surface for about 1 minute or more. Methods of forming a battery includes the method of forming the coating and further includes disposing an anode on the coating and disposing the cathode on the solid-state electrolyte opposite the coating. The anode can be a lithium-containing anode.

This application claims the benefit of priority of Chinese Application Serial No. 202310369561.8 filed on Apr. 7, 2023, the content of which is relied upon and incorporated herein by reference in their entirety.

### FIELD

The present disclosure relates to coatings, batteries, and methods of manufacturing thereof, and more particularly batteries comprising a coating on a solid-state electrolyte and methods of making the same.

### BACKGROUND

Solid-state batteries (SSBs) (e.g., SS lithium (Li) metal batteries based on inorganic solid-state electrolytes (SSEs) (such as garnet-type SSE)) have attracted much attention due to their high safety, improved energy density, high ionic conductivity, and stability against Li metal. However, conventional Li-metal batteries often suffer from issues with capacity retention and/or longevity, especially when operated at higher capacities. Consequently, there is a need to address these issues.

### SUMMARY

The present disclosure provides coatings, batteries, and methods of making the same comprising a coating disposed on a solid-state electrolyte. The coating can comprise lithium and fluorine (e.g., comprise and/or consist of lithium fluoride). The coating can comprise a surface composition with a high concentration of fluorine (e.g., about 10 atom % F or more, about 30 atom % F or more). The coating can be positioned between the solid-state electrolyte and an anode (e.g., lithium-containing anode). The coating can be substantially uniform over the surface of the solid-state electrolyte. Providing the coating (e.g., substantially uniform coating) can enable decreased interfacial resistance, high charging current density (e.g., about 5 mAh/cm² or more, about 6 mAh/cm² or more at 60° C.), increased longevity (e.g., 200 cycles or more), and high capacity retention (e.g., 80% or more, 90% or more, 95%, or more or 98% or more when cycled at 1C from an initial capacity of 3.67 mAh/cm²).

Methods of the present disclosure can form the coating using a single-step process of disposing an aqueous solution on the solid-state electrolyte. The process can be complete in 10 minutes or less (e.g., from 1 minute to 10 minutes, from 3 minutes to 10 minutes) with a small volume of the aqueous solution (e.g., from about 5 μL/cm² to about 50 μL/cm², from about 10 μL/cm² to about 30 μL/cm²) comprising a lithium and fluorine containing salt. Providing the lithium and fluorine containing salt in an aqueous solution can facilitate the formation of the coating on the first major surface of the solid-state electrolyte. Without wishing to be bound by theory, the solid-state electrolyte can react with the water of the aqueous solution to form lithium hydroxide (Li(OH)₂), and/or the fluorine containing compound can react with lithium from the solid-state electrolyte (e.g., as lithium hydroxide or as part of the solid-state electrolyte) to from the coating on the first major surface of the solid-state electrolyte. The material of the coating 110, for example, lithium fluoride has a low solubility in water (e.g., less than 0.2 grams per 100 milliliters of water), which enables the water of the aqueous solution to further facilitate the formation of the coating on the first major surface of the solid-state electrolyte. In contrast, other common solvents used in batteries (see Comparative Examples BB and CC herein) are not capable of preforming the above-mentioned activities.

Providing a solid-state electrolyte (e.g., in a solid-state battery) can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery. Providing an interlayer comprising a liquid electrolyte can wet the interface between the cathode and the solid-state electrolyte to reduce interfacial resistance therebetween while minimizing a total amount of liquid electrolyte in the solid-state battery.

Some example aspects of the disclosure are described below with the understanding that any of the features of the various aspects may be used alone or in combination with one another.

Aspect 1. A method of forming a coating on a solid-state electrolyte:

disposing an aqueous solution comprising a lithium and fluorine containing salt on a first major surface of the solid-state electrolyte, wherein the aqueous solution contacts the first major surface for about 1 minute or more.

Aspect 2. The method of aspect 1, wherein the lithium and fluorine containing salt comprises at least one of: lithium tetrafluoroborate (LiBF₄), lithium hexafluorophosphate (LiPF₆), lithium difluorophosphate (LiPF₂O₂), lithium hexafluorosilicate (Li₂SiF₆), lithium hexafluoroaluminate (Li₃AlF₆), lithium hexafluoroarsenate (LiAsF₆), lithium hexafluoroantimonate (LiSbF₆), lithium bis(trifluoromethanesulfonyl)imide (LiTFSI), lithium bis(fluorosulfonyl)imide (LiFSI), or combinations thereof.

Aspect 3. The method of any one of aspects 1-2, wherein a concentration of the lithium and fluorine containing salt is from 0.5 molar to about 5 molar.

Aspect 4. The method of any one of aspects 1-3, wherein a ratio of a volume of the aqueous solution disposed on the first major surface to a surface area of the first major surface is in a range from about 5 μL/cm² to about 50 μL/cm².

Aspect 5. The method of any one of aspects 1-4, wherein the aqueous solution contacts the first major surface for from about 3 minutes to about 10 minutes.

Aspect 6. The method of any one of aspects 1-5, wherein the coating comprises a thickness in a range from about 1 nanometer to about 1,000 nanometers.

Aspect 7. The method of aspect 6, wherein the thickness of the coating is in a range from about 100 nanometers to about 500 nanometers.

Aspect 8. The method of any one of aspects 1-7, wherein a surface of the coating comprises fluorine in a range from about 10 atom % to about 50 atom %.

Aspect 9. The method of any one of aspects 1-8, wherein the coating comprises lithium fluoride.

Aspect 10. The method of any one of aspects 1-9, wherein the coating is substantially uniform over the first major surface of the solid-state electrolyte.

Aspect 11. The method of any one of aspects 1-10, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or a combination thereof.

Aspect 12. The method of any one of aspects 1-11, further comprising, before the disposing the aqueous solution, mechanically polishing the first major surface of the solid-state electrolyte or treating the first major surface of the solid-state electrolyte with an acidic solution.

Aspect 13. A method of making a battery, comprising:
the method of any one of aspects 1-12;
disposing a lithium-containing anode on the coating, the coating positioned between the lithium-containing anode and the solid-state electrolyte; and
disposing a cathode on the solid-state electrolyte opposite the coating.

Aspect 14. The method of aspect 13, further comprising, disposing a liquid electrolyte on the cathode such that the liquid electrolyte is positioned between the solid-state electrolyte and the cathode.

Aspect 15. The method of aspect 14, wherein the liquid electrolyte comprises a lithium salt in a solvent, the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 16. The method of aspect 15, wherein the solvent comprises sulfolane, and a concentration of the lithium salt in the liquid electrolyte ranges from about 1 molar to about 3 molar.

Aspect 17. The method of any one of aspects 14-16, wherein a ratio of a volume of the liquid electrolyte to a surface area of the cathode is in a range from about 10 μL/cm² to about 50 μL/cm².

Aspect 18. The method of any one of aspects 13-17, wherein the battery can achieve a charging rate of 5C or more at an areal capacity of 1 mAh/cm² based on a surface area of the lithium-containing anode at 60° C.

Aspect 19. The method of any one of aspects 13-17, wherein the battery can achieve an areal capacity of at least 3.5 mAh/cm² based on a surface area of the lithium containing anode when charged at 1C at 60° C.

Aspect 20. The method of any one of aspects 13-17, wherein the battery comprises a capacity retention of about 95% or more after 200 cycles at 1C to an initial areal capacity of 3.67 mAh/cm² at 60° C.

Aspect 21. A battery, comprising:
a cathode;
a solid-state electrolyte;
a coating disposed on the solid-state electrolyte, the coating opposite the cathode; and
a lithium-containing anode disposed on the solid-state electrolyte, the coating positioned between the lithium-containing anode and the solid-state electrolyte, wherein the coating comprises fluorine in an range from about 10 atom % to about 50 atom %.

Aspect 22. The battery of aspect 21, wherein a thickness of the coating is in a range from about 1 nanometer to about 1,000 nanometers.

Aspect 23. The battery of any one of aspects 21-22, wherein the coating comprises lithium fluoride.

Aspect 24. The method of any one of aspects 21-23, wherein the coating is substantially uniform over a first major surface of the solid-state electrolyte.

Aspect 25. The battery of any one of aspects 21-24, wherein the battery can achieve a charging rate of 5C or more at an areal capacity of 1 mAh/cm² based on a surface area of the lithium-containing anode at 60° C.

Aspect 26. The battery of any one of aspects 21-24, wherein the battery can achieve an areal capacity of at least 3.5 mAh/cm² based on a surface area of the lithium containing anode when charged at 1C at 60° C.

Aspect 27. The battery of any one of aspects 21-24, wherein the battery comprises a capacity retention of about 95% or more after 200 cycles at 1C to an initial areal capacity of 3.67 mAh/cm² at 60° C.

Aspect 28. The battery of any one of aspects 21-27, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or a combination thereof.

Aspect 29. The battery of any one of aspects 21-28, further comprising a liquid electrolyte positioned between the solid-state electrolyte and the cathode.

Aspect 30. The battery of aspect 29, wherein the liquid electrolyte comprises a lithium salt in a solvent, the lithium salt comprises at least one of: lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof.

Aspect 31. The battery of aspect 30, wherein the solvent comprises sulfolane, and a concentration of the lithium salt in the liquid electrolyte ranges from about 1 molar to about 3 molar.

Aspect 32. The battery of any one of aspects 29-31, wherein a ratio of a volume of the liquid electrolyte to a surface area of the cathode is in a range from about 10 μL/cm² to about 50 μL/cm².

Aspect 33. The battery of any one of aspects 21-32, wherein the cathode comprises at least one of lithium cobaltite (LCO), lithium manganite spinel (LMO), lithium nickel cobalt aluminate (NCA), lithium nickel manganese cobalt oxide (NCM) (LiNi_{d}CO_{c}Mn_{1-d-e}O₂, where 0<d<1, 0<e<1), lithium iron phosphate (LiFePO₄) (LFP), lithium cobalt phosphate (LCP), lithium titanate, lithium niobium tungstate, lithium nickel manganate, and lithium titanium sulfide (LiTiS₂), or combinations thereof.

### BRIEF DESCRIPTION OF THE DRAWINGS

The above and other features and advantages of aspects of the present disclosure are better understood when the following detailed description is read with reference to the accompanying drawings, in which:

FIG. 1 schematically illustrates a general structure of a solid-state battery in accordance with aspects of the disclosure;

FIG. 2 illustrates a simplified solid-state battery with a coating in accordance with aspects of the disclosure;

FIG. 3 illustrates a step in an exemplary method comprising disposing an aqueous solution on a solid-state electrolyte;

FIG. 4 illustrates a step in an exemplary method comprising disposing a liquid electrolyte over a cathode;

FIG. 5 illustrates a step in an exemplary method comprising disposing the solid-state electrolyte over the cathode;

FIG. 6 schematically illustrates a scanning electron microscope (SEM) image of Comparative Example AA;

FIG. 7 schematically illustrates a SEM image of Comparative Example BB;

FIG. 8 schematically illustrates a SEM image of Comparative Example CC;

FIG. 9 schematically illustrates a SEM image of Example 1;

FIG. 10 schematically illustrates a SEM image of cross-section of Example 1;

FIG. 11 illustrates capacity-voltage (CV) curves for Example 1;

FIG. 12 illustrates capacity-voltage (CV) curves for Comparative Example AA;

FIG. 13 illustrates capacity-voltage (CV) curves for Comparative Example BB;

FIG. 14 illustrates capacity-voltage (CV) curves for Example 2;

FIG. 15 illustrates capacity-voltage (CV) curves for Comparative Example DD;

FIG. 16 illustrates capacity-voltage (CV) curves for Comparative Example CC; and

FIG. 17 illustrates the capacity retention of Example 3 and Comparative Example EE.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

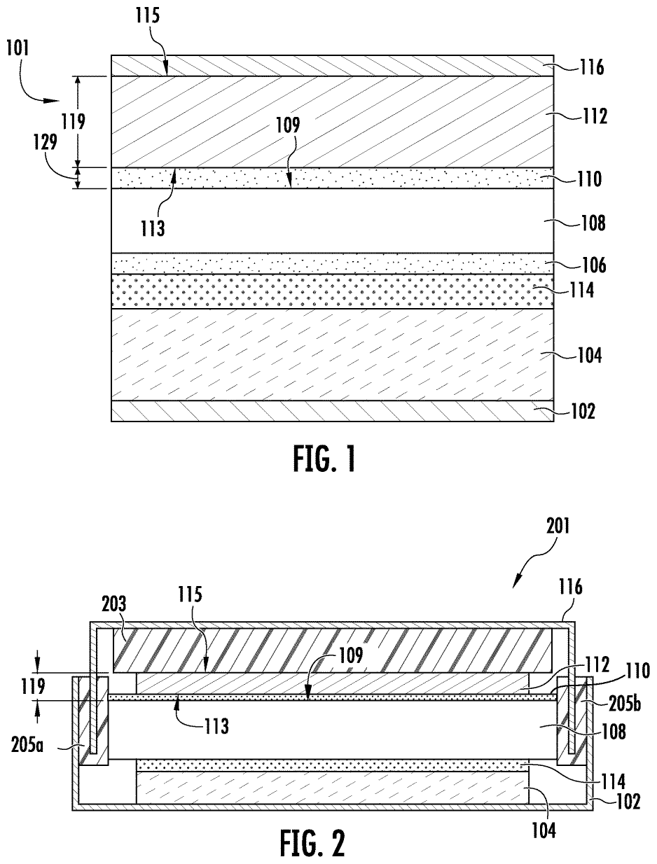

FIGS. 1-2 illustrate views of a solid-state battery 101 or 201 comprising an coating 110 in accordance with aspects of the disclosure. In aspects, the coating 110 can comprise and/or consist of lithium fluoride. In aspects, the coating 110 can be adhered to a solid-state electrolyte 108. As shown, the coating 110 is positioned between the solid-state electrolyte 108 and an anode 112. Unless otherwise noted, a discussion of features of aspects of one coating or battery can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

FIG. 1 schematically illustrates a general structure of a solid-state battery 101, and FIG. 2 illustrates a simplified solid-state battery 201 in a coin-cell form. As shown in FIG. 1, the solid-state battery 101 or 201 can include, sequentially, a first current collector 102 (e.g., substrate), a cathode 104 disposed on the first current collector 102, an optional interlayer 114 disposed on the cathode 104, an optional first coating 106, the solid-state electrolyte 108, the coating 110, and the anode 112, and a second current collector 116 disposed on the anode 112. As shown in FIG. 1, the solid-state battery 101 can optionally comprise a first coating 106 disposed on the cathode 104. As shown in FIGS. 1-2, the solid-state electrolyte 108 is positioned between the cathode 104 and the anode 112. The components of the solid-state battery 101 can be disposed horizontally in relation to each other or vertically.

The first current collector 102 comprises an electrically conductive material. As used herein, electrically conductive materials have an electronic conductivity of 100 Siemens per meter (S/m) measured at 20° C. in accordance with ASTME1004-17. In aspects, the first current collector can comprise nickel (Ni) foam, carbon fiber, or a solid metal contact (e.g., aluminum, stainless steel, copper, platinum, nickel, gold, zinc, cobalt, nickel, ruthenium, lithium, lead, titanium, nichrome, etc.). In aspects, the first current collector 102 can be a mechanically stable and/or dimensionally stable substrate that supports the other elements of the solid-state battery 101 or 201. In aspects, the first current collector 102 can comprise the same material as the cathode 104 (discussed below) such that the first current collector 102 is part of the cathode 104.

The cathode 104 comprises an electrically conductive material. In aspects, the cathode 104 can be configured to release and reincorporate a cation (e.g., alkali metal—lithium or sodium, alkali earth metal—magnesium or calcium). In aspects, the cathode 104 can comprise at least one of an alkali metal (e.g., lithium, sodium) or an alkaline earth metal (e.g., magnesium, calcium). In aspects, the cathode 104 can comprise one or more of the materials discussed below for the anode 112. In further aspects, the cathode 104 can comprise the same material as the anode 112. In aspects, the cathode 104 can comprise a fluoride compound. In further aspects, the cathode 104 can comprise at least one transition metal, for example, cobalt, manganese, nickel, niobium, tantalum, vanadium, titanium, copper, chromium, tungsten, molybdenum, tin, germanium, antimony, bismuth, iron, or combinations thereof. In aspects, the cathode 104 can comprise a lithium-based electrode, for example lithium cobaltite (LCO), lithium manganite spinel (LMO), lithium nickel cobalt aluminate (NCA), lithium nickel manganese cobalt oxide (NCM) (LiNi_{d}Co_{c}Mn_{1-d-e}O₂, where 0<d<1, 0<e<1, for example, LiNi_{0.5}Co_{0.2}Mn_{0.3}O₂ (NCM523), LiNi_{0.6}Co_{0.2}Mn_{0.2}O₂ (NCM622), etc.), lithium iron phosphate (LiFePO₄) (LFP), lithium cobalt phosphate (LCP), lithium titanate, lithium niobium tungstate, lithium nickel manganate, lithium titanium sulfide (LiTiS₂), or combinations thereof. In aspects, the cathode 104 can comprise a sodium-based electrode, for example, NaVPO₄F, NaMnO₂, Na_{2/3}Mn_{1-y}Mg_{y}O₂ (0<y<1), Na₂Li₂TisO₁₂, Na₂Ti₃O₇, or combinations thereof. In aspects, the cathode 104 can comprise a magnesium-based electrode, for example, magnesiochromite (MgCr₂O₄), MgMn₂O₄, or combinations thereof. The cathode 104 can be a sintered electrode. Alternatively, the cathode 104 can be unsintered. An exemplary aspect of a cathode 104 is a NCM cathode.

As shown in FIG. 1, the solid-state battery 101 can optionally comprises an interlayer 114 positioned between the cathode 104 and the solid-state electrolyte 108. In aspects, the interlayer 114 can comprise a liquid electrolyte (e.g., ionic liquid, deep eutectic solvent (DES), or an aprotic solvent). As used herein, an “electrolyte” enables the transport of ions therein (“ion conductivity”), and the ion conductivity corresponds to an electrical conductivity of the electrolyte (e.g., DES-based electrolyte). The interlayer 114 can be a liquid at room temperature (i.e., 25° C.) and/or at an operating temperature of the solid-state battery 101 (e.g., from about 50° C. to about 60° C.). In aspects, the liquid electrolyte can comprise a lithium-containing salt and a solvent. In further aspects, the lithium-containing salt can comprise one or more of lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiSO₃CF₃), LiC(SO₂CF₃)₃, or combinations thereof. In further aspects, a concentration of the lithium-containing salt can be about 0.5 molar (M) or more, about 1 M or more, about 1.2 M or more, about 1.5 M or more, about 3 M or less, about 2.5 M or less, or about 2 M or less, for example, in a range from about 0.5 M to about 3 M, from about 1 M to about 3 M, from about 1.2 M to about 2.5 M, from about 1.5 M to about 2 M, or any range or subrange therebetween. An exemplary aspect of the solvent is sulfolane, although other solvents are possible in other aspects. Providing an interlayer 114 comprising a liquid electrolyte can wet the interface between the cathode 104 and the solid-state electrolyte to reduce interfacial resistance therebetween while minimizing a total amount of liquid electrolyte in the solid-state battery 101.

As shown in FIGS. 1-2, the solid-state battery 101 and 201 comprises the solid-state electrolyte 108 positioned between the cathode 104 and the anode 112. Throughout the disclosure, “solid-state batteries” comprise a solid-state electrolyte. As used herein, a solid-state electrolyte is a material that is solid at room temperature and at an operating temperature (e.g., about 50° C.) of the solid-state battery. In aspects, the solid-state electrolyte 108 can comprise an inorganic solid-state electrolyte. Providing a solid-state electrolyte can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery.

In aspects, the solid-state electrolyte 108 can comprise a lithium-phosphorous-oxynitride (LiPON), lithium garnet (Li₇La₃Zr₂O₁₂), lithium phosphosulfide, or combinations thereof. In further aspects, a LIPON material can comprise the structure Li_{3+y}PO₄₋ₓNₓ, where y>0 and 0<x<4. In further aspects, the solid-state electrolyte 108 can comprise lithium, lanthanum, zirconium, oxygen, or combinations thereof (e.g., each of lithium, lanthanum, zirconium, and oxygen-a LLZO compound). As used herein, “LLZO” refers to compounds including lithium, lanthanum, zirconium, and oxygen. In even further aspects, the solid-state electrolyte 108 can comprise a lithium-garnet, for example, at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga or Fe and 0<x<4), or a combination thereof. In aspects, the solid-state electrolyte 108 can comprise at least one of Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

In aspects, the optional first coating 106 can comprise a carbon-based interlayer (e.g., interlinked freestanding, micro/mesopore containing, functionalized, biomass-derived), a polymer-based interlayer, a metal-based coating (e.g., Ni foam, etc.), a liquid electrolyte (e.g., LiPF₆ in ethylene carbonate (EC)/dimethyl carbonate (DMC)), ionic liquid-based (e.g., LiCF₃SO₃/CH₃CONH₂, LiTFSI/N-methylacetamide (NMA), PEO₁₈LiTFSI-10% SiO₂-10% IL, etc., where LiTFSI is bis(trifluoromethane) sulfonimide lithium salt (LiN(CF₃SO₂)₂), SiO₂ may be nanoparticles, and IL is an ionic liquid), or a combination thereof. Exemplary aspects of polymer-based interlayers include carbon polysulfides (CS), polyethylene oxides (PEO), polyaniline (PANI), polypyrrole (PPY), poly(3,4-ethylenedioxythiophene) (PEDOT), poly(styrene sulfonic acid) (PSS), polyacrylonitrile (PAN), polyacrylic acid (PAA), polyallylamine hydrochloride (PAH), poly(vinylidene fluoride-co-hexafluoropropylene) (P(VDF-co-HFP)), poly(methyl methacrylate) (PMMA), polyvinylidene fluoride (PVDF), poly(diallyldimethyl ammonium) bis(trifluoromethanesulfonyl)imide (TFSI) (PDDATFSI), or combinations thereof. In aspects, the first coating 106 can comprise at least one of, or at least two of, or at least three elements selected from a group consisting of nitrogen, carbon, cobalt, titanium, tantalum, and tungsten.

In aspects, the coating 110 comprises a lithium and fluorine containing material. In further aspects, the coating 110 can comprise and/or consist of lithium fluoride. As discussed below, the coating 110 can be formed through a reaction with a lithium and fluorine containing compound in an aqueous solution and the solid-state electrolyte. As used herein, a composition of the coating is determined using energy dispersive X-ray analysis (EDX). In aspects, the composition can comprise fluorine, as measured by EDX, of about 10 atom % or more, about 15 atom % or more, about 20 atom % or more, about 25 atom % or more, about 30 atom % or more, about 35 atom % or more, about 50 atom % or less, about 45 atom % or less, about 42 atom % or less, about 40 atom % or less, about 38 atom % or less, about 37 atom % or less, about 36 atom % or less, about 35 atom % or less, about 32 atom % or less, about 30 atom % or less, or about 28 atom % or less. In aspects, the composition can comprise fluorine, as measured by EDX, in a range from about 10 atom % to about 50 atom %, from about 15 atom % to about 45 atom %, from about 20 atom % to about 42 atom %, from about 25 atom % to about 40 atom %, from about 30 atom % to about 38 atom %, from about 35 atom % to about 37 atom %, from about 35 atom % to about 36 atom %, or any range or subrange therebetween.

As shown in FIGS. 1-2, the coating 110 is positioned between the solid-state electrolyte 108 (e.g., a first major surface 109 of the solid-state electrolyte 108) and the anode 112 (e.g., a first major surface 113 of the anode 112). In aspects, the coating 110 can be disposed on the first major surface 109 of the solid-state electrolyte 108, for example, by being adhered (e.g., directly adhered to and contacting) the first major surface 109 of the solid-state electrolyte 108. As shown in FIG. 1, a coating thickness 129 of the coating 110 is an average thickness of the coating 110 between a first major surface 109 of the solid-state electrolyte 108 and a first major surface 113 of the anode 112. In aspects, the coating thickness 129 can be about 1 nanometer (nm) or more, about 10 nm or more, about 50 nm or more, about 80 nm or more, about 100 nm or more, about 120 nm or more, about 150 nm or more, about 170 nm or more, about 180 nm or more, about 190 nm or more, about 200 nm or more, about 1,000 nm or less, about 800 nm or less, about 700 nm or less, about 600 nm or less, about 500 nm or less, about 400 nm or less, about 300 nm or less, about 250 nm or less, about 220 nm or less, about 210 nm or less, about 200 nm or less, about 190 nm or less, or about 180 nm or less. In aspects, the coating thickness 129 can be in a range from about 1 nm to about 1,000 nm, from about 10 nm to about 800 nm, from about 50 nm to about 700 nm, from about 100 nm to about 600 nm, from about 120 nm to about 500 nm, from about 150 nm to about 400 nm, from about 170 nm to about 300 nm, from about 180 nm to about 250 nm, from about 190 nm to about 220 nm, from about 200 nm to about 210 nm, or any range or subrange therebetween. In aspects, as shown in FIG. 1, the coating 110 can be substantially uniform over the first major surface 109 of the solid-state electrolyte 108.

As shown in FIGS. 1-2, the anode 112 can be disposed on the solid-state electrolyte 108. In aspects, as shown in FIG. 2, the first major surface 113 of the anode 112 can be disposed on the first major surface 109 of the solid-state electrolyte 108. In further aspects, the coating 110 can contact the first major surface 109 of the solid-state electrolyte 108. As shown, the anode 112 comprises a second major surface 115 opposite the first major surface 113 with an anode thickness 119 defined as an average distance therebetween when the solid-state battery 201 is in a fully charged state (defined below). In aspects, the anode thickness 119 can be about 1 micrometer (μm) or more, about 10 μm or more, about 50 μm or more, about 100 μm or more, about 150 μm or more, about 500 μm or less, about 400 μm or less, about 300 μm or less, or about 250 μm or less. In aspects, the anode thickness 119 can range from about 1 μm to about 500 μm, from about 10 μm to about 400 μm, from about 50 μm to about 300 μm, from about 100 μm to about 300 μm, from about 150 μm to about 250 μm, or any range or subrange therebetween.

The anode 112 is a lithium-containing anode. In aspects, the lithium-containing anode can consist essentially of lithium. Alternatively, in aspects, the lithium-containing anode can comprise an alloy of lithium and at least one of magnesium (Mg), silver (Ag), or combinations thereof. In further aspects, the lithium-containing alloy can further comprise a second component selected from a group consisting of calcium (Ca), aluminum (Al), gallium (Ga), boron (B), carbon (C), silicon (Si), tin (Sn), zinc (Zn), indium (In), antimony (Sb), silver (Ag), and combinations thereof. Exemplary aspects of the second component include calcium (Ca), tin (Sn), and silver (Ag). Providing a lithium-containing anode comprise a lithium alloy can increase a wettability of the anode on the coating, which can decrease interfacial resistance of the battery (e.g., by achieving and/or maintaining good contact with the solid-state electrolyte through the coating), facilitate a high area capacity of the battery, and/or facilitate a high charging current density of the battery.

FIG. 2 illustrates a solid-state battery 201 comprising the coating 110. As shown in FIG. 2, the solid-state battery 201 can comprise a coin-cell form, although the battery can comprise another form in other aspects. Compared to FIG. 1, FIG. 2 is a simplified solid-state battery 201 because the optional first coating 106 is omitted. Consequently, the interlayer 114 can be in direct contact with the cathode 104 and the solid-state electrolyte 108, for example, because the optional first coating 106 is omitted. In aspects, as shown in FIG. 2, the area of the first major surface 113 of the anode 112 can be less than or equal to (e.g., less than) the area of the first major surface 109 of the solid-state electrolyte 108. In further aspects, as shown, the area of the first major surface 113 of the anode 112 can be substantially equal to a corresponding area of the cathode 104. Alternatively, as shown in FIG. 1, the area of the first major surface 113 of the anode 112 can be substantially equal to the area of the first major surface 109 of the solid-state electrolyte 108. In aspects, as shown in FIG. 2, an electrically insulating layer 205a and 205b can be positioned between the first current collector 102 and the second current collector 116 to prevent a short circuit in the solid-state battery 201 and/or to form a barrier protecting the contents of the solid-state battery 201. As used herein, the electrically insulating layer 205a and 205b comprises an electronic conductivity of 10⁻⁵ S/cm or less. In even further aspects, as shown, the electrically insulating layer 205a and 205b can be configured to maintain a configuration of the solid-state battery 201, for example, by preventing the solid-state electrolyte 108 from contacting the second current collector 116. In further aspects, the electrically insulating layer 205a and 205b can comprise a polymeric material, for example, a fluoropolymer, a rubber, a polyurethane, or a silicone. In aspects, as shown, the solid-state battery 201 can further comprise an electrically conductive spacer 203 positioned between the anode 112 and the second current collector 116. In further aspects, the electrically conductive spacer 203 can comprise a foam (e.g., Ni foam), which can help maintain contact between adjacent components of the solid-state battery and/or control an amount of stress that the components of the solid-state battery are subjected to. Although not shown, an electrically conductive spacer can be positioned between the cathode and the first current collector.

Unless otherwise specified, a cycle comprises charging at 1C to a predetermined nominal areal capacity and discharged at 1C while the battery is maintained at 60° C. As used herein, “nominal capacity” (e.g., nominal areal capacity) refers to a capacity achieved using a predetermined charging condition in a first charging step for the battery. Areal capacity is presented based on a surface area of the anode. Unless otherwise indicated, battery testing including capacity retention and cycling at various nominal areal capacity is performed using the battery test system CT2001A (Landt) at 60° C. In aspects, after 200 cycles (e.g., charging and discharging at 1C and 60° C.) to a predetermined nominal area capacity of 3.67 mAh/cm², the battery can comprise a capacity retention of 80% or more, 85% or more, 90% or more, 93% or more, 95% or more, 96% or more, 97% or more, 98% or more, 99% or more, or about 100%. In aspects, the battery can achieve an areal capacity (based on a surface area of the anode) can be about 3.5 mAh/cm² or more (e.g., when charged at 1C and 60° C.). In aspects, the battery can withstand (e.g., at least 5 cycles, at least 9 cycles, 10 cycles or more) a charging rate of 5C (5 mAh/cm²) or more at a nominal areal capacity of 1 mAh/cm². In aspects the battery can withstand (e.g., 5 cycles or more) charging at 2C (6 mAh/cm²) or more to a nominal areal capacity of 3 mAh/cm² and discharging at 0.33C (e.g., at 60° C.). Consequently, providing the coating 110 can enable high charging current density (e.g., about 5 mAh/cm² or more, about 6 mAh/cm² or more at 60° C.), increased longevity (e.g., 200 cycles or more), and high capacity retention (e.g., 80% or more, 90% or more, 95%, or more or 98% or more when cycled at 1C from an initial capacity of 3.67 mAh/cm²).

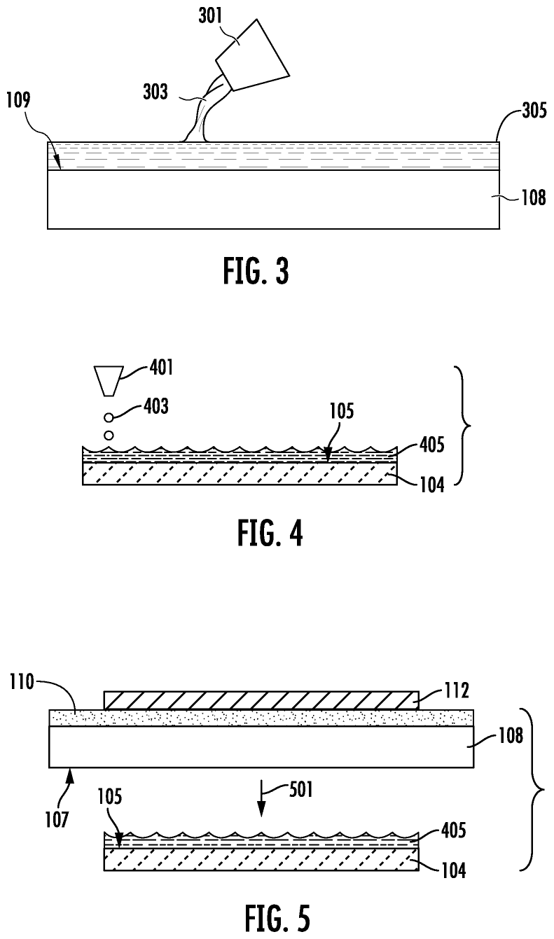

Aspects of methods of making the coating and/or the solid-state battery in accordance with aspects of the disclosure will be discussed with reference to example method steps illustrated in FIGS. 3-5. Methods can comprise providing a solid-state electrolyte, which can comprise one or more of the materials discussed above with reference to the solid-state electrolyte. In aspects, methods can comprise mechanically polishing (e.g., using a “sandpaper” such as silicon carbide) the first major surface 109 of the solid-state electrolyte 108 and/or treating the first major surface 109 of the solid-state electrolyte 108 using an acidic solution (e.g., using a mineral acid solution). For example, mechanically polishing and/or otherwise treating the first major surface of the solid-state electrolyte can provide a smooth surface and/or remove contaminants (e.g., carbonate-containing compounds) at the first major surface. As used herein, the surface profile is measured over a test area of 10 μm by 10 μm as measured using atomic force microscopy (AFM), which is used to characterize the first major surface of the solid-state electrolyte using parameters defined in ISO 4287:1997. As used herein, surface roughness Ra is calculated as an arithmetical mean of the absolute deviation of a surface profile from an average position. In aspects, the first major surface 109 of the solid-state electrolyte 108 can comprise a surface roughness Ra of about 1 μm or less, about 0.8 μm or less, about 0.6 μm or less, about 0.5 μm or less, about 0.4 μm or less, about 0.1 μm or more, about 0.2 μm or more, or about 0.3 μm or more, for example, in a range from about 0.1 μm to about 1 μm, from about 0.2 μm to about 0.8 μm, from about 0.3 μm to about 0.7 μm, from about 0.3 μm to about 0.6 μm, from about 0.4 μm to about 0.5 μm, or any range or subrange therebetween.

As shown in FIG. 3, methods can comprise disposing an aqueous solution 303 comprising a lithium and fluorine containing salt on the first major surface 109 of the solid-state electrolyte 108. In aspects, as shown, the aqueous solution 303 can be dispensed from a container 301 (e.g., conduit, flexible tube, micropipette, or syringe) onto the first major surface 109 of the solid-state electrolyte 108 as a layer 305 of the aqueous solution 303. As used herein, an aqueous solution of “X” means that “X” is dissolved in solvent comprising water. Aqueous solutions can further comprise additional solvents other than water, for example, another solvent miscible with water (e.g., ethanol). In aspects, the solvent of the aqueous solution can consist essentially of water and/or consist of water. In aspects, a concentration the lithium and fluorine containing salt in the aqueous solution 303 can be about 0.5 M or more, about 0.8 M or more, about 1 M or more, about 1.2 M or more, about 1.5 M or more, about 5 M or less, about 3 M or less, about 2 M or less, about 1.5 M or less, or about 1.2 M or less. In aspects, a concentration the lithium and fluorine containing salt in the aqueous solution 303 can range from about 0.5 M to about 5 M, from about 0.8 M to about 3 M, from about 1 M to about 2 M, from about 1.2 M to about 1.5 M, or any range or subrange therebetween. In aspects, a ratio of a volume of the aqueous solution 303 disposed on the first major surface 109 (e.g., a volume of the layer 305) to a surface area of the first major surface 109 can be about 5 microliters per centimeter squared (μL/cm²) or more, about 8 μL/cm² or more, about 10 μL/cm² or more, about 15 μL/cm² or more, about 50 μL/cm² or less, about 30 μL/cm² or less, about 20 L/cm² or less, or about 15 μL/cm² or less. In aspects, the ratio of a volume of the aqueous solution 303 disposed on the first major surface 109 to a surface area of the first major surface 109 can be in a range from about 5 μL/cm² to about 50 μL/cm², from about 8 μL/cm² to about 30 μL/cm², from about 8 μL/cm² to about 20 μL/cm², from about 10 μL/cm² to about 15 μL/cm², or any range or subrange therebetween. In aspects, the lithium and fluorine containing salt can comprise at least one of lithium tetrafluoroborate (LiBF₄), lithium hexafluorophosphate (LiPF₆), lithium difluorophosphate (LiPF₂O₂), lithium hexafluorosilicate (Li₂SiF₆), lithium hexafluoroaluminate (Li₃AlF₆), lithium hexafluoroarsenate (LiAsF₆), lithium hexafluoroantimonate (LiSbF₆), lithium bis(trifluoromethanesulfonyl)imide (LiTFSI), lithium bis(fluorosulfonyl)imide (LiFSI), or combinations thereof.

In aspects, the aqueous solution 303 can be in contact with the first major surface 109 of the solid-state electrolyte 108 for a predetermined period of time of about 1 minute or more, about 2 minutes or more, about 3 minutes or more, about 4 minutes or more, about 5 minutes or more, about 10 minutes or less, about 8 minutes or less, about 6 minutes or less, or about 5 minutes or less. In aspects, the aqueous solution 303 can be in contact with the first major surface 109 of the solid-state electrolyte 108 for a predetermined period of time in a range from about 1 minute to about 10 minutes, from about 2 minutes to about 8 minutes, from about 2 minutes to about 6 minutes, from about 3 minutes to about 5 minutes, from about 4 minutes to about 5 minutes or any range or subrange therebetween. Providing the aqueous solution of the lithium and fluorine containing salt in contact with the first major surface of the solid state electrolyte for at least 1 minute can enable a reaction to occur between the lithium and fluorine containing compound, water, and/or the material of the solid-state electrolyte. Providing the lithium and fluorine containing salt in an aqueous solution can facilitate the formation of the coating 110 on the first major surface of the solid-state electrolyte. Without wishing to be bound by theory, the solid-state electrolyte can react with the water of the aqueous solution to form lithium hydroxide (Li(OH)₂), and/or the fluorine containing compound can react with lithium from the solid-state electrolyte (e.g., as lithium hydroxide or as part of the solid-state electrolyte) to from the coating on the first major surface of the solid-state electrolyte. The material of the coating 110, for example, lithium fluoride has a low solubility in water (e.g., less than 0.2 grams per 100 milliliters of water), which enables the water of the aqueous solution to further facilitate the formation of the coating on the first major surface of the solid-state electrolyte. In contrast, other common solvents used in batteries (see Comparative Examples BB and CC below) are not capable of preforming the above-mentioned activities. After the predetermined period of time, the aqueous solution can be removed from the first major surface of the solid-state electrolyte. For example, the aqueous solution can be wiped (e.g., manually) from the first major surface, for example, using a KimWipe (Kimtech) or a paper towel, and/or by rinsing the first major surface with another liquid, for example, an alcohol (e.g., ethanol).

After the contacting the first major surface 109 of the solid-state electrolyte 108 with the aqueous solution 303, the coating can comprise one or more of the aspects discussed above for the coating 110. For example, the coating 110 can comprise and/or consist of lithium fluoride. The coating can comprise fluorine in atom % within one or more of the corresponding ranges discussed above. The coating 110 can comprise a coating thickness 129 within one or more of the ranges discussed above for the coating thickness 129. The coating 110 can be substantially uniform over the first major surface 109 of the solid-state electrolyte 108. For methods of forming the coating 110, methods can be complete.

In aspects, as shown by comparing FIG. 3 and FIG. 4, methods of making a battery (e.g., solid-state battery) can further comprise disposing an anode 112 over the first major surface 109 of the solid-state electrolyte 108 (e.g., disposed on the coating 110). In aspects, disposing the lithium-containing material for the anode 112 can comprise deposition from a gas phase, for example, by sputtering from one or more sources (e.g., elemental targets or an alloy target) and/or by thermal evaporation, although other methods of physical vapor deposition (PVD) can be used to form the anode 112. Alternatively, disposing the lithium-containing material for the anode 112 can comprise disposing a molten material (e.g., lithium metal, lithium alloy) on the first major surface 109 of the solid-state electrolyte 108, for example, from a metal foil, a conduit, a micropipette, or a syringe. Alternatively, the lithium-containing material can be disposed on the solid-state electrolyte by attaching a metal foil comprising the lithium-containing material (e.g., lithium metal, lithium alloy) to the first major surface of the solid-state electrolyte, which can be subsequently heated to enable the lithium-containing metal to conform to a surface of the coating. In aspects, the lithium-containing metal on the coating 110 can be heated in an environment (e.g., an oven) maintained at a first temperature that is greater than a melting point of the one or more materials in the lithium-containing material used to form the anode. In further aspects, the first temperature can be greater than a melting point of the one or more materials used to form the anode by about 50° C. or more, about 100° C. or more, about 125° C. or more, or about 150° C. or more. For example, lithium metal has a melting temperature of about 180° C. In further aspects, the first temperature can be about 280° C. or more, about 300° C. or more, about 320° C. or more, about 500° C. or less, about 400° C. or less, or about 350° C. or less, for example, from about 280° C. to about 500° C., from about 300° C. to about 400° C., from about 320° C. to about 350° C., or any range or subrange therebetween. In further aspects, the solid-state electrolyte 108, the coating 110, and the lithium-containing material disposed thereon can be maintained at the first temperature for about 1 minute or more, about 3 minutes or more, about 5 minutes or more, about 15 minutes or more, about 20 minutes or more, about 1 hour or less, about 45 minutes or less, about 30 minutes or less, or about 25 minutes or less, for example, for a time ranging from about 1 minute to about 1 hour, from about 3 minutes to about 45 minutes, from about 5 minutes to about 30 minutes, from about 15 minutes to about 30 minutes, from about 20 minutes to about 25 minutes, or any range or subrange therebetween. Providing a temperature and time within one or more of the above-mentioned ranges can enable the lithium-containing material to conform to a surface on the coating 110.

In aspects, as shown in FIG. 4, methods can further comprise disposing an interlayer 114 by disposing a liquid electrolyte 405 on the cathode 104. In further aspects, the liquid electrolyte can comprise a lithium salt and a solvent, which can comprise one or more of the materials discussed above for the interlayer 114. In further aspects, a concentration of the lithium salt in the solvent can be within one or more of the corresponding ranges discussed above. In further aspects, as shown, disposing the liquid electrolyte 405 can comprise dispensing a predetermined amount of the liquid 403 from a container 401 (e.g., conduit, flexible tube, micropipette, or syringe) to form the liquid electrolyte 405 on a first major surface 105 of the cathode 104. In further aspects, the predetermined amount of the interlayer 114 (e.g., liquid electrolyte 405) as a ratio of a volume of the interlayer (e.g., liquid electrolyte) to an area of the first major surface of the cathode can be within one or more of the corresponding ranges discussed above. Providing the ratio of the volume of the interlayer to the area of the first major surface of the cathode can be sufficient to wet the interface between the cathode and the solid-state electrolyte while minimizing concerns associated with traditional liquid electrolytes (e.g., in liquid-based batteries or in hybrid liquid-solid batteries). Although not shown, the cathode can be disposed on the first current collector while the interlayer is disposed on the cathode.

In aspects, as shown in FIG. 5, method can further comprise disposing the solid-state electrolyte 108 on the cathode 104, as indicated by arrow 501. As shown, the cathode 104 can be opposite the first major surface 109 of the solid-state electrolyte 108, the coating 110, and/or the anode 112. As shown, the solid-state electrolyte 108 is positioned between the cathode 104 and the anode 112, and/or the coating is positioned between the cathode 104 and the anode 112. Although not shown, additional elements (e.g., current collectors) can be present when the solid-state electrolyte is disposed on the cathode and/or additional elements can be added after disposing the cathode to form the battery (e.g., solid-state battery 101 or 201).

### Examples

Various aspects will be further clarified by the following examples. Examples (Ex) 1-3 and Comparative Examples (CE) AA-EE comprise NCM523 cathode with a diameter of 12 mm, a lithium garnet (discussed below) solid-state electrolyte with a diameter of 14 mm and a thickness of 0.6 mm, the anode comprised a lithium-containing material. In Example 1 and Comparative Examples AA-BB, the anode consisted of lithium metal. In Examples 2-3 and Comparative Examples CC-EE, the anode comprised a lithium alloy of 10 atom % magnesium with the balance as lithium metal. NCM523 refers to LiNi_{0.5}Co_{0.2}Mn_{0.3}O₂ (precursor commercially available from Landt Instruments), which was formed into slurry with a 8:1:1 weight ratio of the precursor, super P carbon black (available from Timcal-Imerys), and poly(vinylidene fluoride) (PVDF) (dissolved in N-methylpyrrolidone) that was coated on aluminum (Al) foil with a predetermined thickness and dried under vacuum. The NCM523 cathode sheet has a mass loading of 20 mg/cm². After contacting the solid-state electrolyte with an solution in Examples 1-3 and Comparative Examples BB-CC, the lithium-containing material for the anode was disposed on the coating and heated at 300° C. for 5 minutes. In Comparative Examples AA and DD-EE, no solution (or other coating precursor) was disposed on the solid-state electrode before the lithium-containing material for the anode was disposed on the coating and heated at 300° C. for 5 minutes. In Examples 1-3 and Comparative Examples AA-EE, 10 μL/cm² of a liquid electrolyte comprising 1.2 M LIFSI dissolved in sulfolane was disposed on the cathode, and then the solid-state electrolyte was disposed over the cathode with the liquid electrolyte positioned therebetween to form a battery resembling the solid-state battery 201 shown in FIG. 2 in a CR2025 coin cell form with Ni foam disposed over the anode.

The lithium garnet solid-state electrolyte was cubic phase Li_{6.5}La₃Zr_{1.4}Ta_{0.5}O₁₂ (LLZTO), which was synthesized from a stoichiometric ratio of starting powders of LiOH·H₂O (AR), La₂O₃ (99.99%), ZrO₂ (AR), Ta₂O₅ (99.99%). 2 wt % excess of LiOH·H₂O added to compensate the lithium loss during processing. La₂O₃ was heated at 900° C. for 12 hours to remove any moisture and/or CO₂. The raw materials were mixed via a wet grinding process in which yttrium-stabilized zirconium oxide (YSZ) balls and isopropanol (IPA) were used as the milling media. The mixture was dried and calcined at 950° C. for 6 hours in an alumina crucible to obtain pure cubic garnet phase powder. These powders were pressed into green pellets and sintered at 1230° C. for 1 hour, covered with LLZTO powder with 15 wt % Li excess in platinum crucibles.

Before assembly, the lithium garnet solid-state electrolyte sheets were dry polished with 800-grit SiC sandpaper followed by immersing in 1 mol/L HCl solution for 5 minutes. After that, 10 μL/cm² of a solution (see Table 1 below) was disposed on a first major surface of the solid-state electrolyte for 1 minute with the excess removed by wiping followed by rinsing with ethanol. Then, in an argon-filled glovebox, the anode-precursor (e.g., alloy) was disposed over the first major surface of the lithium garnet solid-state electrolyte and was heated at 300° C. for 5 minutes followed by naturally cooling to room temperature (e.g., 25° C.) to form the anode on the lithium garnet solid-state electrolyte. An interlayer was formed comprising 1.2 molar lithium bis(fluorosulfonyl)imide (LIFSI) in sulfolane with a volume of 10 μL per square centimeter (μL/cm²) of a major surface of the cathode was disposed on the cathode before the lithium garnet solid-state electrolyte was disposed thereon. An Ni foam with the same diameter as the anode was placed on the top of the anode, and the battery was sealed in a CR2025 coin cell with an applied pressure of 5 MPa.

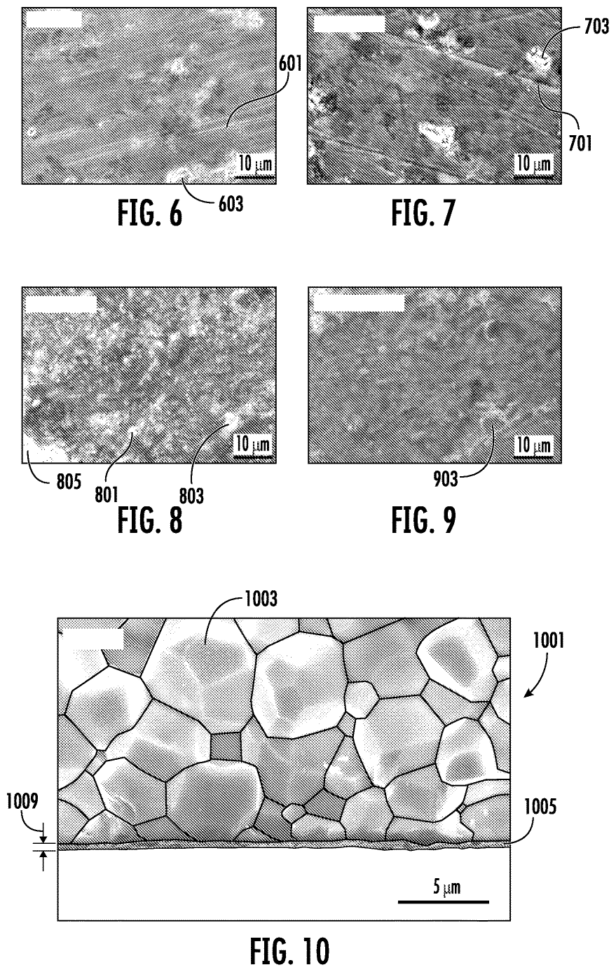

As shown in Table 1, Examples 1-3 were treated with an aqueous solution, Comparative Example BB was treated with a propylene carbonate solution, Comparative Example CC was treated with a sulfolane solution, and Comparative Examples AA and DD-EE were not treated with any solution. FIGS. 6-8 schematically represent SEM images of the first major surface of the solid-state electrode after any treatment and before the anode was formed thereon for Comparative Examples AA-CC, respectively, with the contrast enhanced to improve visibility. As shown in FIG. 6, Comparative Example AA has scratches 601 (e.g., from the sandpaper) and surface irregularities 603 (e.g., garnet granules) visible, but no coating other material is visible. Comparative Examples AA and DD-EE did not have any detectable fluorine on the first major surface. As shown in FIG. 7, Comparative Example DD has scratches 701 and surface irregularities 703 present as well. Compared to FIG. 6, the surface irregularities 703 have a plurality of particles clustered around them, and these particles are believed to correspond to fluorine-containing material. Comparative Example DD has 3 atom % fluorine, suggesting that the coating was limited (perhaps just to the particles around the surface irregularities). As shown in FIG. 8, scratches are not discernable for Comparative Example EE, but there are surface irregularities and other patchiness 805 visible. It is believed that the patchiness 805 corresponds to particles of fluorine-containing material (similar to Comparative Example DD) that appear to be more broadly distributed than for Comparative Example DD. Comparative Example DD has 4 atom % fluorine, suggesting that the coating was limited. Consequently, the lithium and fluorine containing material in propylene carbonate or sulfolane (Comparative Examples DD-EE) do deposit substantial amounts of fluorine-containing material and the SEM images indicate that this material is not homogenously distributed across the surface of the solid-state electrolyte.

TABLE 1
Properties of Examples 1-3 and Comparative Examples AA-EE

| | | | | | Maximum | | |
|---|---|---|---|---|---|---|---|
| | | | | | Nominal Areal | Maximum | |
| | | | Fluorine | Surface | Capacity tested | Charge | |
| Example | Anode | Solution | atom % | Appearance | (mAh/cm²) | Rate | |
| Ex. 1 | Li metal | 1M LiBF₄ in | 37 | Full | 1 | 7 | C |
| | | water | | coating | | | |
| CE AA | Li metal | None | 0 | No coating | 1 | 3 | C |
| CE BB | Li Metal | 1M LiBF₄ in | 3 | Particles | 1 | 2 | C |
| | | propylene | | | | | |
| | | carbonate | | | | | |
| Ex 2 | Li_{0.9}Mg_{0.1} | 1M LiBF₄ in | 37 | Full | 3 | 2 | C* |
| | | water | | coating | | | |
| CE CC | Li_{0.9}Mg_{0.1} | 1M LiBF₄ in | 4 | Particles | 3 | 1.3 | C |
| | | sulfolane | | | | | |
| CE DD | Li_{0.9}Mg_{0.1} | None | 0 | No coating | 3 | 1.3 | C |
| Ex. 3 | Li_{0.9}Mg_{0.1} | 1M LiBF₄ in | 37 | Full | 3.67 | 1 | C^{#} |
| | | water | | coating | | | |
| CE EE | Li_{0.9}Mg_{0.1} | None | 0 | No coating | 3.67 | 1 | C^{#} |

*= Example 2 withstood the highest charge rate tested without abnormal discharge
^{#}= Example 2 and Comparative Example EE were charged at 1 C for all cycles

FIGS. 9-10 schematically represent SEM images of the first major surface of the solid-state electrode after treatment with the aqueous solution and before the anode was formed thereon for Example 1. FIG. 9 shows a substantially uniform coating over the first major surface (as indicated by the darker color in FIG. 9 compared to FIGS. 6-8 before the contrast was enhanced) with coated surface irregularities 903 visible. As shown in Table 1, the first major surface of Example 1 comprises 37 atom % fluorine. FIG. 10 shows a cross-section of Example 1, where granules 1003 of garnet in the solid-state electrolyte are visible with the coating 1005 disposed thereon. The coating 1005 is substantially uniform over the surface of the solid-state electrolyte 1001 with a coating thickness 1009 of about 200 nm. Compared to the limited and particulate coatings in Comparative Examples BB-CC, it is unexpected that a high fluorine surface content (e.g., 10 atom % or more, 20 atom % or more, or 30 atom % or more) and substantially uniform coating can be achieved by changing the solvent to water.

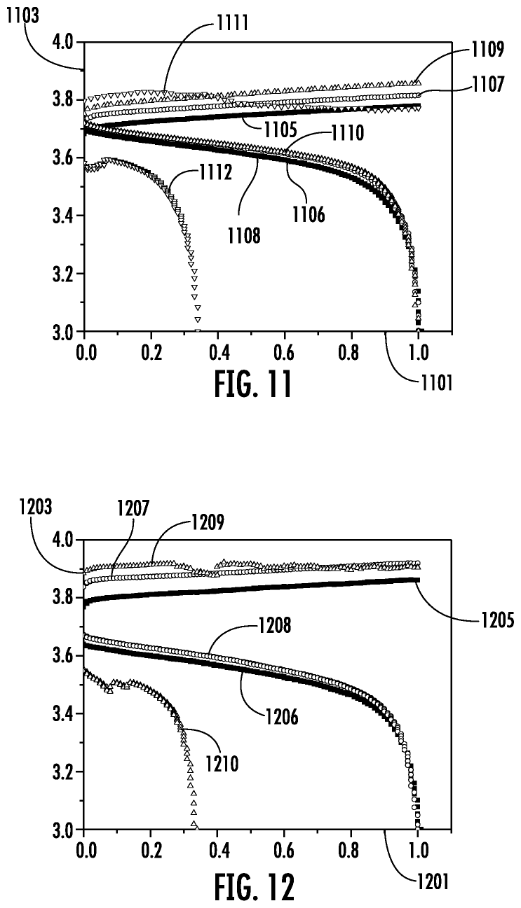

As shown in FIGS. 11-13, Example 1 and Comparative Examples AA-BB were tested at a nominal capacity of 1 mAh/cm² various charging current densities (“charging rates”) starting at 1C and increasing by 2C every 10 cycles with the last curve measured for each charging rate (until failure) shown for simplicity. If the sample failed at 3C, an additional test was done on a new cell prepared identically where the charging rate started at 1C and increased by 1C every 10 cycles (as was the case for Comparative Examples AA-BB). For Example 1 and Comparative Examples AA-BB the discharge current rate was maintained at 1C for all cycles. FIG. 11 shows capacity-voltage (CV) curves for Example 1 with the horizontal axis 1101 corresponding to instantaneous capacity (in mAh/cm²) and the vertical axis 1103 corresponding to voltage (V). In FIG. 11, curves 1105, 1107, 1109, and 1111 correspond to discharging curves at 1C as part of the cycles with charging at 1C, 3C, 5C, and 7C, respectively. Curves 1106, 1108, 1110, and 1112 correspond to charging curves at 1C, 3C, 5C, and 7C, respectively. The charging curves up to 7C (e.g., 5C or less) appear normal. Curve 1111 shows some irregularity during discharging and curve 1112 indicates that there was a short circuit during subsequent charging at 7C.

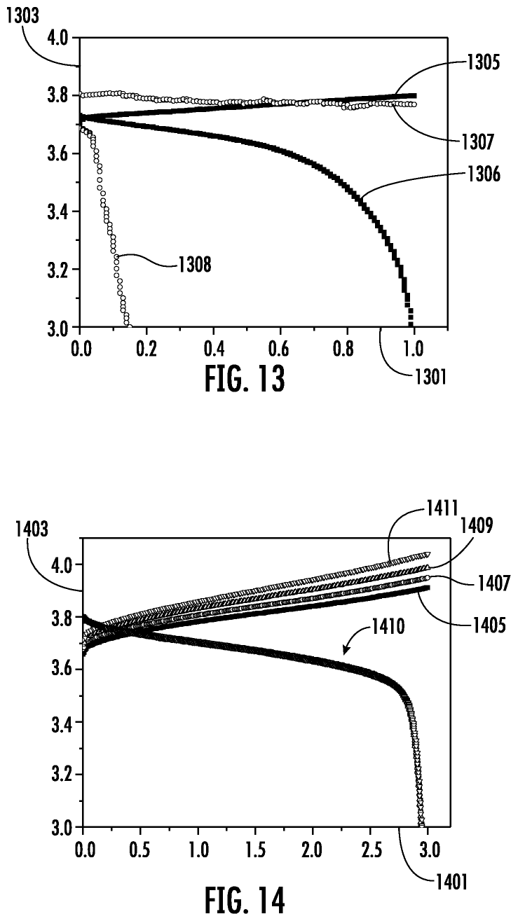

FIGS. 12-13 show capacity-voltage (CV) curves for Comparative Examples AA-BB, respectively, with the horizontal axis 1201 and 1301 corresponding to instantaneous capacity (in mAh/cm²) and the vertical axis 1203 and 1303 corresponding to voltage (V). For Comparative Example AA, as shown in FIG. 12, curves 1205, 1207, and 1209 correspond to discharging curves 1C as part of cycles with charging at 1C, 2C, and 3C, respectively. Curves 1206, 1208, and 1210 correspond to charging curves at 1C, 2C, and 3C, respectively. Discharging curve 1209 shows irregularities, and charging curve 1210 indicates that there was a short circuit at 3C. For Comparative Example BB, as shown in FIG. 13, curves 1305 and 1307 are discharging curves at 1C and 2C, respectively. Curves 1306 and 1308 are charging curves at 1C and 2C, respectively. Discharging curve 1307 shows irregularities, and charging curve 1308 indicates that there was a short circuit during subsequent charging at 2C. Consequently, Comparative Examples AA-BB were unable to withstand at least 10 cycles at 3C while Example 1 was able to withstand at least 10 cycles at 5C. Also, Comparative Example BB (propylene glycol) performed worse than Comparative Example AA (no treatment), indicating that any deposition from the treatment (e.g., fluorine-particles shown in FIG. 6) did not improve the charging performance of the battery while the substantially uniform coating of Example 1 (see FIGS. 8-9) did improve battery charging performance.

As shown in FIGS. 14-16, Example 2 and Comparative Examples CC-DD were tested at a nominal capacity of 3 mAh/cm² various charging current densities (“charging rates”) starting at 1C and increasing by 0.3C every 10 cycles with the last curve measured for each charging rate (until failure) shown for simplicity. Examples 2 and Comparative Examples CC-DD were discharged at 0.3 C for all cycles. FIG. 14 shows capacity-voltage (CV) curves for Example 1 with the horizontal axis 1401 corresponding to instantaneous capacity (in mAh/cm²) and the vertical axis 1403 corresponding to voltage (V). In FIG. 14, curves 1405, 1407, 1409, and 1411 correspond to discharging curves at 0.3C as part of the cycles with charging at 1C, 1.3C, 1.6C, and 2C, respectively. Curves 1410 correspond to charging curves at 1C, 1.3C, 1.6C, and 2C, respectively, with the curves superimposing on one another. All of the charging and discharging curves in FIG. 14 appear normal, indicating that Example 2 can withstand charging at 2C or more for a nominal capacity of 3 mAh/cm².

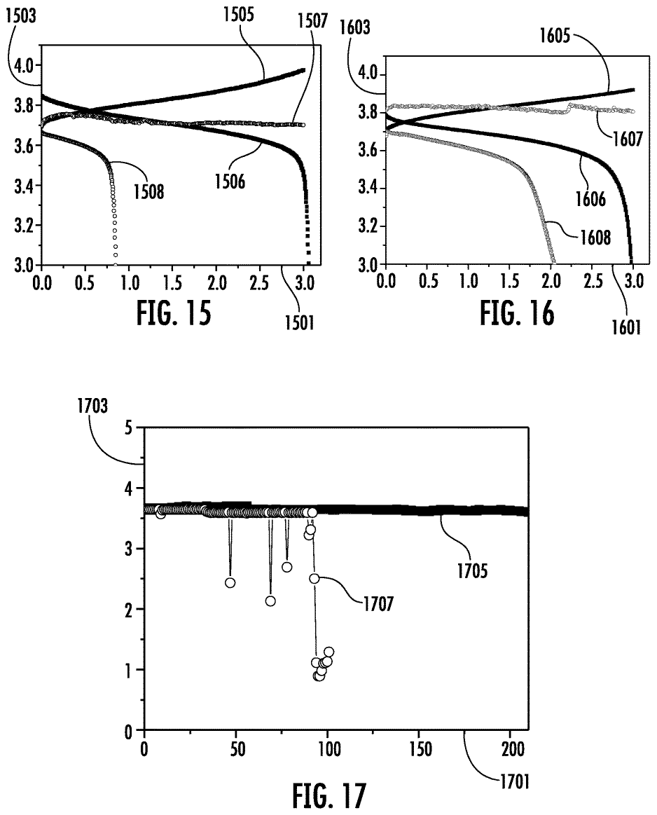

FIGS. 15-16 show capacity-voltage (CV) curves for Comparative Examples DD and CC with the horizontal axis 1501 and 1601 corresponding to instantaneous capacity (in mAh/cm²) and the vertical axis 1503 and 1603 corresponding to voltage (V) for Comparative Examples DD and CC, respectively. For Comparative Example DD, as shown in FIG. 15, curves 1505 and 1507 correspond to discharging curves at 0.3C 1C as part of the cycles with charging at 1C and 1.3C, respectively. Curves 1506 and 1508 correspond to charging curves at 1C, 2C, and 3C, respectively. Discharging curve 1507 is irregular, and charging curve 1508 indicates that there was a short circuit at 1.3C. For Comparative Example BB, as shown in FIG. 16, curves 1605 and 1607 are discharging curves at 0.3 C as part of the cycles with charging at 1C and 1.3C, respectively. Curves 1606 and 1608 are charging curves at 1C and 1.3C, respectively. Discharging curve 1607 shows irregularities, and charging curve 1608 indicates that there was a short circuit during subsequent charging at 1.3C. Consequently, Comparative Examples CC-DD were unable to withstand at least 10 cycles at 1.3C (to a nominal capacity of 3 mAh/cm²) while Example 1 was able to withstand at least 10 cycles at 2C. Also, Comparative Example CC (sulfolane) did not perform any better than Comparative Example DD (no treatment), indicating that any deposition from the treatment (e.g., fluorine-particles shown in FIG. 7) did not improve the charging performance of the battery while the substantially uniform coating of Example 2 (see FIGS. 8-9) did improve battery charging performance.

FIG. 17 shows the capacity performance of Example 3 and Comparative Example EE when cycles to a nominal capacity of 3.67 mAh/cm² with a charging rate of 1C and a discharging rate of 1C at 60° C. In FIG. 17, horizontal axis 1701 represents the cycle number, and vertical axis 1703 corresponds to the actual capacity at the end of charging for the corresponding cycle in mAh/cm². Curve 1705 corresponds to Example 3, and curve 1707 corresponds to Comparative Example EE. As shown, Example 3 (curve 1705) does not exhibit any irregularities and had a final actual capacity (after 217 cycles) of 3.62 mAh/cm² (98.6% of nominal initial capacity), demonstrating that Example 3 can maintain 80% or more, 85% or more, 90% or more, 95% or more, and/or 98% or more of the initial capacity after 200 cycles or more under these testing conditions. In contrast, Comparative Example EE (curve 1707) exhibited significant irregularities starting around cycle 50 and eventually failing around cycle 100. Consequently, the lithium and fluoride containing coating on the first major surface of the solid-state electrolyte formed by the aqueous solution can increase cycling stability and/or longevity of the battery by at least a factor of two.

The above observations can be combined to provide coatings, batteries, and methods of making the same comprising a coating disposed on a solid-state electrolyte. The coating can comprise lithium and fluorine (e.g., comprise and/or consist of lithium fluoride). The coating can comprise a surface composition with a high concentration of fluorine (e.g., about 10 atom % F or more, about 30 atom % F or more). The coating can be positioned between the solid-state electrolyte and an anode (e.g., lithium-containing anode). The coating can be substantially uniform over the surface of the solid-state electrolyte. Providing the coating (e.g., substantially uniform coating) can enable decreased interfacial resistance, high charging current density (e.g., about 5 mAh/cm² or more, about 6 mAh/cm² or more at 60° C.), increased longevity (e.g., 200 cycles or more), and high capacity retention (e.g., 80% or more, 90% or more, 95%, or more, or 98% or more when cycled at 1C from an initial capacity of 3.67 mAh/cm²).

Methods of the present disclosure can form the coating using a single-step process of disposing an aqueous solution on the solid-state electrolyte. The process can be complete in 10 minutes or less (e.g., from 1 minute to 10 minutes, from 3 minutes to 10 minutes) with a small volume of the aqueous solution (e.g., from about 5 μL/cm² to about 50 μL/cm², from about 10 μL/cm² to about 30 μL/cm²) comprising a lithium and fluorine containing salt. Providing the lithium and fluorine containing salt in an aqueous solution can facilitate the formation of the coating on the first major surface of the solid-state electrolyte. Without wishing to be bound by theory, the solid-state electrolyte can react with the water of the aqueous solution to form lithium hydroxide (Li(OH)₂), and/or the fluorine containing compound can react with lithium from the solid-state electrolyte (e.g., as lithium hydroxide or as part of the solid-state electrolyte) to from the coating on the first major surface of the solid-state electrolyte. The material of the coating 110, for example, lithium fluoride has a low solubility in water (e.g., less than 0.2 grams per 100 milliliters of water), which enables the water of the aqueous solution to further facilitate the formation of the coating on the first major surface of the solid-state electrolyte. In contrast, other common solvents used in batteries (see Comparative Examples BB and CC herein) are not capable of preforming the above-mentioned activities.

Providing a solid-state electrolyte (e.g., in a solid-state battery) can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery. Providing an interlayer comprising a liquid electrolyte can wet the interface between the cathode and the solid-state electrolyte to reduce interfacial resistance therebetween while minimizing a total amount of liquid electrolyte in the solid-state battery.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1. A method of forming a coating on a solid-state electrolyte:
disposing an aqueous solution comprising a lithium and fluorine containing salt on a first major surface of the solid-state electrolyte, wherein the aqueous solution contacts the first major surface for about 1 minute or more.

2. The method of claim 1, wherein the lithium and fluorine containing salt comprises at least one of: lithium tetrafluoroborate (LiBF₄), lithium hexafluorophosphate (LiPF₆), lithium difluorophosphate (LiPF₂O₂), lithium hexafluorosilicate (Li₇SiF₆), lithium hexafluoroaluminate (Li₃AlF₆), lithium hexafluoroarsenate (LiAsF₆), lithium hexafluoroantimonate (LiSbF₆), lithium bis(trifluoromethanesulfonyl)imide (LiTFSI), lithium bis(fluorosulfonyl)imide (LiFSI), or combinations thereof.

3. The method of claim 1, wherein a concentration of the lithium and fluorine containing salt is from 0.5 molar to about 5 molar.

4. The method of claim 1, wherein a ratio of a volume of the aqueous solution disposed on the first major surface to a surface area of the first major surface is in a range from about 5 μL/cm² to about 50 μL/cm².

5. The method of claim 1, wherein the coating comprises a thickness in a range from about 1 nanometer to about 1,000 nanometers.

6. The method of claim 1, wherein a surface of the coating comprises fluorine in a range from about 10 atom % to about 50 atom %.

7. The method of claim 1, wherein the coating comprises lithium fluoride.

8. The method of claim 1, wherein the coating is substantially uniform over the first major surface of the solid-state electrolyte.

9. The method of claim 1, wherein the solid-state electrolyte comprises at least one of:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof.

10. The method of claim 1, further comprising, before the disposing the aqueous solution, mechanically polishing the first major surface of the solid-state electrolyte or treating the first major surface of the solid-state electrolyte with an acidic solution.

11. A method of making a battery, comprising:
the method of claim 1;
disposing a lithium-containing anode on the coating, the coating positioned between the lithium-containing anode and the solid-state electrolyte; and
disposing a cathode on the solid-state electrolyte opposite the coating.

12. A battery, comprising:
a cathode;
a solid-state electrolyte;
a coating disposed on the solid-state electrolyte, the coating opposite the cathode; and
a lithium-containing anode disposed on the solid-state electrolyte, the coating positioned between the lithium-containing anode and the solid-state electrolyte,
wherein the coating comprises fluorine in a range from about 10 atom % to about 50 atom %.

13. The battery of claim 12, wherein a thickness of the coating is in a range from about 1 nanometer to about 1,000 nanometers.

14. The battery of claim 12, wherein the coating comprises lithium fluoride.

15. The method of claim 12, wherein the coating is substantially uniform over a first major surface of the solid-state electrolyte.

16. The battery of claim 12, wherein the battery can achieve a charging rate of 5C or more at an areal capacity of 1 mAh/cm² based on a surface area of the lithium-containing anode at 60° C.

17. The battery of claim 12, wherein the battery can achieve an areal capacity of at least 3.5 mAh/cm² based on a surface area of the lithium containing anode when charged at 1C at 60° C.

18. The battery of claim 12, wherein the battery comprises a capacity retention of about 95% or more after 200 cycles at 1C to an initial areal capacity of 3.67 mAh/cm² at 60° C.

19. The battery of claim 12, wherein the solid-state electrolyte comprises at least one of:
(i) Li₇₋₃ₐLa₃Zr₂LₐO₁₂, with L=Al, Ga, or Fe and 0<a<0.33;
(ii) Li₇La₃₋₆Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof.

20. The battery of claim 12, further comprising a liquid electrolyte positioned between the solid-state electrolyte and the cathode.
